(19) United States
(12) Patent Application Publication
(10) Pub. No.: US 2007/0278943 A1
(43) Pub. Date: Dec. 6, 2007

(54) Multicolor Electroluminescent Element

(75) Inventors: Manfred Hartmann, Ziegelberg/Petershausen (DE); Wolfgang Perzlmeier, Landshut (DE); Oliver Narwark, Munich (DE)

Correspondence Address: NIXON PEABODY, LLP, 401 9TH STREET, NW, SUITE 900, WASHINGTON, DC, 20004-2128, US

(73) Assignee: Schreiner Group GmbH & Co., KG, Oberschleissheim (DE)

(21) Appl. No.: 10/594,721

(22) PCT Filed: Apr. 4, 2005
(86) PCT No.: PCT/EP05/03535

§ 371 Date: Jul. 25, 2007

(30) Foreign Application Priority Data
Apr. 22, 2004 (DE) 10 2004 019 611.7

(51) Int. Cl. H01J 1/70

(52) U.S. Cl. 313/506

(57) ABSTRACT

The electroluminescent (EL) element comprises a transparent plastic film substrate (1) onto whose rear side a transparent first electrode layer (2) comprised of indium tin oxide (ITO) is vacuum sputtered. A first electroluminescent layer (3) with dispersed electroluminophores (4) is placed on the first electrode layer (2). This first electroluminescent layer consists of a transparent matrix (5) into which the electroluminophores (4) are incorporated (4). The second electrode layer (rear electrode layer) (6) is placed on the first electroluminescent layer (3) or on an insulating intermediate layer (not shown) located thereon. This second electrode layer is insulated toward its side facing away from the first electroluminescent layer (3) by means of the insulating layer (7). On the front side, i.e. the visible face, a third electrode layer (8) comprised of transparent conductive lacquer is applied to the plastic film substrate (1). A second electroluminescent layer (9) with dispersed electroluminophores (4) is placed on the third electrode layer (8). The fourth electrode layer (10) comprised of transparent conductive lacquer is placed on said second electroluminescent layer (9) or on an insulating intermediate layer (not shown) located thereon. This fourth electrode layer (10) is insulated on the visible face by means of an insulating layer (11).

The present invention relates to a multicolor electroluminescent element.

Electroluminescence technology has increasingly gained in significance in recent time. It allows the implementation of nearly arbitrarily large homogeneous luminescent surfaces which are free of screens and shadows. The power consumption and overall depth (in the magnitude of a millimeter or less) are extremely low. In addition to the background illumination of monochrome liquid crystal displays, typical applications include the backlighting of transparent films which are provided with inscriptions and/or graphic motifs.

Electroluminescence (in short: EL) is understood as the direct luminescent excitation of luminescent pigments and/or luminophores by an electrical AC field. Electroluminescent elements (in short: EL elements) based on thick-film technology using inorganic luminescent pigments and/or luminophores and AC voltage excitation have become widespread. Thick-film EL elements are less complex and thus more cost-effective to produce than thin-film EL elements.

The luminescent pigments and/or luminophores are embedded in a transparent organic or ceramic binder. Starting materials are typically zinc sulfides, which generate different, relatively narrow-band emission spectra as a function of doping or co-doping and preparation procedure. The focal point of the spectrum determines the particular color of the emitted light.

The exciting AC voltage field typically has a frequency of a few hundred hertz, the effective value of the operating voltage frequently being in a range from approximately 50 to 150 volts. By elevating the voltage, a higher light density may normally be achieved, which is typically in a range from approximately 50 to approximately 200 candela per square meter. Elevating the frequency usually causes a color shift toward lower wavelengths. Both parameters must be tailored to one another in order to achieve a desired light impression, however.

In principle, two types of electrodes suggest themselves above all for the production of typical thick-film EL elements using AC voltage excitation. One type are indium-tin oxide electrodes (ITO) which are sputtered or vapor-deposited onto plastic films in vacuum. They are very thin (a few hundred angstroms) and offer the advantage of high transparency at a relatively low resistance per unit area (approximately 60 to 600 ohms/square). In addition, printing pastes having ITO or ATO (antimony-tin oxides) or conductive transparent polymer pastes may be used. At a thickness of approximately 5 to 20 μm, electrodes of this type offer only lesser transparency at a high resistance per unit area (up to 50 kohm/square). However, they may be applied having largely any arbitrary texture, even onto textured surfaces. Furthermore, they offer a relatively good laminating ability as well as restricted ability to be deformed.

The service life of an EL element is limited. It is a function above all of the level and frequency of the AC voltage applied, in addition, however, also environmental influences, in particular the effect of moisture and UV radiation. The service life of an EL element is typically specified as a half-life value of the luminescent pigments. This is the time after which the luminance has been reduced to half of the starting value under the influence of the electrical field with unchanged operating conditions. In practice, the luminance falls to half of the original value within approximately 2000 to 3000 hours of operation.

The emission color of an EL element may be tailored to the desired color impression through multiple possible measures. These include doping and co-doping of the luminescent pigments, mixing two or more EL pigments, adding one or more organic and/or inorganic color-converting and/or color-filtering pigments, coating the EL element using organic and/or inorganic color-converting and/or color-filtering substances, adding colorants to the polymer matrix in which the luminescent pigments are dispersed, and incorporating a color-converting and/or color-filtering layer or film in the structure of the EL element.

There is frequently a need for EL elements which may luminesce multicolored, i.e., alternately in different colors as a function of an external controller. Corresponding EL elements are referred to as multicolor electroluminescent elements.

Multicolor electroluminescent elements are known, inter alia, from EP-A-1045618. A multicolor EL lamp is described therein, in which different colors result through additive color mixing, in that at least two electroluminescent layers containing luminescent pigments which lie one on top of another are activated appropriately using at least three electrode layers. The first electrode is produced for this purpose using vapor deposition of ITO on a PET substrate, while in contrast all further layers, i.e., also all further electrodes, are produced using screen printing.

A multilayer EL element having different patterns and many luminescence colors is also described in EP-A-0998171. The first transparent electrode is also produced here on a PET film using vapor deposition or sputtering. All further electrodes are produced using printing of optically transparent pastes.

A multicolor EL element which has multiple light-transparent electrode layers and multiple luminescent layers having different colors is known from EP-A-0973358. A multilayer structure produced by printing is also implemented according to this publication.

The structure having multiple luminescent layers produced using screen printing, which all known multicolor EL elements listed share in principle, is connected to some problems. In industrially typical and available electroluminophores, particle diameters of greater than 20 micrometers, typically between 20 and 35 micrometers, and a broad particle size distribution must normally be expected. Therefore, luminescent layer thicknesses of 40 to 60 μm are typical. If coarse-grained pigments of this type are dispersed in screenprinting inks and applied in multiple layers to a carrier substrate, it is obvious that at typical degrees of filling of 65 to 75 weight-percent, a very uneven surface results. The unevenness is caused by the spread of the particle dimensions and, in addition, by the evaporation of solvent during the drying procedure. The unevenness of the surface of each individual layer may be reduced, for example, by using UV-curable polymer binders and/or by using fine-grain luminescent pigments and/or luminescent pigments having a narrower particle size distribution. These problems may thus be controlled in EL elements which are only provided with only one luminescent layer and thus emit monochromatically. However, in multilayer structures, the unevenness of the individual layers adds up randomly, so that multicolor EL elements providing a homogeneous light impression are not producible or are only producible with significant discards in the way described in practice.

Furthermore, an additional leveling printing procedure and/or a leveling lamination procedure may be performed. However, for typical EL elements the disadvantages of process steps of this type outweigh their advantages, since each additional layer reduces the electrical AC field applied, and projecting pigment particles may be pressed into the polymer layer underneath during a lamination procedure, but may just as well penetrate the dielectric insulation and thus influence the function of the particular EL element very disadvantageously.

In addition to these problems of unevenness, there is also the need to guide the individual planar electrodes to typically laterally situated terminal areas. This results in layer height of over 100 μm having to be overcome in a multilayered structure produced through screen printing on a substrate, which may not be achieved using ITO or ETO screen printing inks through single printing and results in a further elevation of the unevenness of the surface through the use of busbar printed formations using silver pastes. This is because even with a single luminescent layer of the above-mentioned typical thickness, insulating layers or dielectric layers must be guided very carefully over the layer edges in order to also be able to guide a rear electrode having good electrical conduction properties over a layer edge of this type.

Therefore, the overall production of typical multicolor EL elements, but particularly the production of the electrical circuitry and/or the terminals of diverse fields, is extremely difficult to control and very susceptible to errors in luminescent layers having segmented structures.

In consideration of the set of problems described, it is the object of the present invention to provide a multicolor electroluminescent element which may assume different luminescent colors as a function of the electrical activation and is nonetheless producible at acceptable outlay in high quality.

This object is achieved according to one aspect of the present invention by a multicolor electroluminescent element according to Claim 1.

EL elements according to the present invention thus differ from the prior art in that the electroluminescent capacitors each having one electroluminescent layer and two electrode layers are situated on both sides of a film substrate. In a multicolor EL element having two electroluminescent capacitors, the structure on one particular side of the film substrate is thus not more complex than in a typical monochromatically emitting EL element. The set of problems of unevenness described above, which grows with a greater number of layers situated one on top of another, is thus minimized.

Preferred embodiments of the multicolor EL element according to the present invention may be implemented according to Claims 2 through 11.

The possible uses of multicolor EL elements according to the present invention are manifold. For example, the background illumination of displays having illumination colors selectable by the user, the different-colored illumination of multifunction operating elements depending on the operating mode in the field of automobiles, for example, advertising displays backlit using changing colors, etc., are conceivable. Multicolor EL elements according to the present invention are very well suitable for representing switching actions (e.g., color change from “on” to “off” through alternate control of the operating voltage to two EL capacitors emitting in different colors). Multiple different colors may be produced through additive color mixing if the different electroluminescent capacitors may each be supplied using multistage or continuously adjustable operating voltage.

If three electroluminescent layers emitting in different colors are required, for example, to provide an RGB system (red/green/blue) capable of displaying the entire color spectrum, above all two types of alternatives are conceivable. Firstly, an EL element according to the present invention having front and rear electroluminescent capacitors may be combined with a typical, transparently implemented EL element only having one electroluminescent capacitor. In addition, one side of a film substrate may be provided with a structure containing one electroluminescent capacitor and the other side may be provided with a structure containing two electroluminescent capacitors. The problems cited of increasing unevenness and difficult wiring occur again, however, with two electroluminescent capacitors lying one on top of another, these problems may be handled in principle, although with the above restrictions. In contrast, three electroluminescent capacitors situated one on top of another on the same side of a film substrate—as an RGB structure according to the prior art would appear—may hardly still be technically implemented at acceptable quality.

An example of a preferred embodiment of the present invention is explained in greater detail on the basis of the attached drawing.

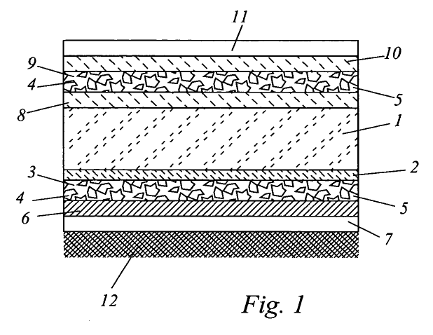

FIG. 1 is a purely schematic cross-sectional illustration of the detail of a multicolor EL element according to the present invention. The area of the electrode terminals is not shown. The illustration is not to scale; in particular, layer thicknesses are greatly enlarged for reasons of clarity. The viewing side, i.e., the side in whose direction light is to be emitted, is on top in the drawing.

The EL element has a transparent plastic film substrate 1, on whose rear side a transparent first electrode layer 2 made of ITO is sputtered or vapor-deposited in vacuum. The materials suitable for the plastic film substrate 1 are manifold, depending on the application, such as polycarbonate (PC), polyalkylene terephthalates, polyamide (PA), polyacrylate, polymethacrylate, polymethyl methacrylate (PMMA), polyurethane (PUR), polyoxymethylene (POM), polyethylene (PE), polypropylene (PP), polystyrene (PS), polyvinyl chloride (PVC), polyamide (PI), polyetherimidene (PEI), polyether, polyether ketones (PEK), polyvinyl fluoride (PVF), polyvinylidene fluoride (PVdF), or similar films, which have a high transparency in the optically visible wavelength range. Films made of polyethylene terephthalate (PET) are especially suitable. Depending on the desired color effect, the plastic film substrate 1 may also contain a colorant and/or color-converting substances. In principle, the substrate 1 may also comprise a material other than a plastic film which is at least transparent.

A first electroluminescent layer 3 having dispersed electroluminophores is situated on the first electrode layer 2, this being a transparent matrix 5 in which the electroluminophores 4 are incorporated. The first electroluminescent layer 3 may be implemented as a cast or extruded film, but also as a screenprinted layer or the like. The illustration of the electroluminophores 4 in particular is to be seen as purely schematic. In practice, the particles are to approximate a spherical shape as much as possible. Electroluminophores are typically sensitive to the effects of moisture. Therefore, additional layers may be integrated, which assume the function of a moisture barrier or vapor barrier. However, these may be largely dispensed with if microencapsulated electroluminophores 4 are used in particular. The microencapsulation is typically oxidic or nitridic, but an organic microencapsulation or a diamond-like carbon encapsulation is also conceivable, for example.

The second electrode layer (rear electrode layer) 6, which is insulated using the insulating layer 7 on its side facing away from the first electroluminescent layer 3, is situated on the first electroluminescent layer 3 or an insulating intermediate layer (not shown) located thereon.

The rear electrode layer 6 may be produced through doctoring, roller coating, curtain casting, spraying, or printing (usually using screen printing) in the form of an intrinsically conductive polymer layer and/or a layer having metal oxides, such as indium-tin oxide (ITO) or antimony-tin oxides (ATO). However, because of its good conductivity and reflection properties, an electrode layer containing silver is especially suitable as the rear electrode layer.

The insulating layer 7 may be a thin lacquer layer or the like, however, an insulating plastic film may also be laminated on in addition to or instead of this layer.

The EL element shown has a self-adhesive coating 12 on its side facing away from the viewing side, using which it may be attached easily to greatly varying surfaces. Of course, with other types of attachment, such as a clamp attachment, the self-adhesive coating may be dispensed with.

On the front side, i.e., on the viewing side, a third electrode layer 8 made of transparent conductive lacquer is applied to the plastic film substrate 1. This may be a doped polythiophene (trade name Orgacon [registered trademark of the Agfa-Gevaert group]). Alternatively, a multicolor EL element according to the present invention may also be produced starting from a plastic film substrate 1 sputtered or vapor-deposited on both sides using ITO. In this case, the third electrode layer 8 comprises ITO, like the first electrode layer 2.

A second electroluminescent layer 9 having dispersed electroluminophores 4 is situated on the third electrode layer 8, this again being a transparent matrix 5 in which the electroluminophores 4 are incorporated. The second electroluminescent layer 9 may also be implemented as a film, screenprinted layer, or the like.

The fourth electrode layer 10 made of transparent conductive lacquer (e.g., a polythiophene), which is insulated on the viewing side using an insulating layer 11, is situated on the second electroluminescent layer 9 or an insulating intermediate layer (not shown) located thereon.

The EL element may be covered partially opaque on the viewing side, for example, using an imprint or additionally provided cover elements, to implement symbols, inscriptions, etc.

Depending on the intended use, one or more of the electrode layers 2, 6, 8, 10 may also be provided over part of the area and/or segmented. Instead of a continuous area, there are then one or more partial areas, which may each be wired separately and thus activated individually. For example, using screen printing technologies known per se, one or both electroluminescent layers 5, 9 may be provided in segments with electroluminophores 4 emitting in different colors to achieve areas luminescing locally in different colors.

In particular in large-area embodiments, it is suggested that the electrode layers 2, 6, 8, 10 be contacted via busbars, i.e., highly conductive structures made of silver and/or copper and/or carbon pastes or the like around the edge and/or around the border.

1. A multicolor electroluminescent element, comprising:
a substrate, which is at least partially transparent over at least part of its area, having a front side and a rear side,
a first electrode layer situated on the rear side of the substrate,
a first electroluminescent layer, having electroluminophores incorporated therein, situated on a side of the first electrode layer facing away from the substrate,
a second electrode layer situated on a side of the first electroluminescent layer facing away from the substrate,
a third electrode layer situated on the front side of the substrate,
a second electroluminescent layer, having electroluminophores incorporated therein, situated on a side of the third electrode layer facing away from the substrate,
a fourth electrode layer, situated on a side of the second electroluminescent layer facing away from the substrate.

2. The multicolor electroluminescent element according to claim 1, wherein at least one of the second and the fourth electrode layer is a transparent conductive lacquer layer.

3. The multicolor electroluminescent element according to claim 1, wherein at least one of the first and third electrode layer is a transparent conductive lacquer layer.

4. The multicolor electroluminescent element according to claim 2, wherein at least one of the conductive lacquer layers at least predominantly comprises an electrically conductive polymer.

5. The multicolor electroluminescent element according to claim 1, wherein at least one of the first and the third electrode layer is vapor deposited onto the substrate.

6. The multicolor electroluminescent element according to claim 1, wherein at least one of the first and third electrode layer at least predominantly comprises indium-tin oxide.

7. The multicolor electroluminescent element according to claim 1, comprising an insulating layer, which is transparent over at least a part of its area, situated on a side of the fourth electrode layer facing away from the substrate.

8. The multicolor electroluminescent element according to claim 1, comprising an insulating layer situated on a side of the second electrode layer facing away from the substrate.

9. The multicolor electroluminescent element according to claim 1, wherein the substrate at least predominantly consists of polyethylene terephthalate.

10. The multicolor electroluminescent element according to claim 1, which has at least one color-filtering layers.

11. The multicolor electroluminescent element according to claim 10, wherein the substrate has color-filtering components.

12. The multicolor electroluminescent element according to claim 1, wherein the electroluminophores incorporated in the first electroluminescent layer have a different emission color than the electroluminophores incorporated in the second electroluminescent layer.

13. The multicolor electroluminescent element according to claim 1, wherein at least one of the first and the third electrode layer is sputtered onto the substrate.

14. The multicolor electroluminescent element according to claim 1, which has at least one color-converting layer.

15. The multicolor electroluminescent element according to claim 14, wherein the substrate has color-converting components.
